(19) United States
(12) Patent Application Publication
(10) Pub. No.: US 2025/0386813 A1
(43) Pub. Date: Dec. 25, 2025

(54) Snap On Weedless Lure Head

(71) Applicant: Todd Steven Nitsche, Athens, TX (US)

(72) Inventor: Todd Steven Nitsche, Athens, TX (US)

(21) Appl. No.: 19/205,524

(22) Filed: Jun. 26, 2025

Related U.S. Application Data
(60) Provisional application No. 63/646,299, filed on May 13, 2024.

(51) Int. Cl. A01K 85/00

(52) U.S. Cl. CPC A01K 85/1811; A01K 85/1857

(57) ABSTRACT

One example embodiment includes a portion of an assembly when securing fishing line to a hook. The embodiment includes a method for a snap-on assembly to a hook. The embodiment may also allow for vertical swivel motion along a fixed axis once affixed to the hook. The embodiment is made of a flexible plastic material that allows the snap feature to expand and contract back to its original shape after attaching. The embodiment further includes an internal pocket for properly aligning and securing the eye of the hook. Furthermore, the embodiment provides a pocket that covers the leading edge of a soft plastic artificial bait.

### BACKGROUND

Currently some lure manufacturers claim to have weedless jig heads, artificial baits and specialty hooks that make the claim to be weedless. However; this is not the case. Existing weedless lures on the market still hang up in grass and underwater structures due to the exposed hook eye and knot. This embodiment solves the problem by providing a snap on, bullet shaped head that covers the areas where grass and other underwater structures still hang up or pick up weeds during the retrieve of the lure and/or hooks.

### BRIEF SUMMARY OF THE INVENTION

An embodiment that contains one or more features that allow it to snap on the eye or shank for a weighted or non-weighted fishing hook. The embodiment has features that align it with the hook for orientation purposes. The embodiment contains a thru hole that allows passage of the fishing line through the nose to tie to the hook eye. The embodiment contains a recessed area that allows over lapping coverage of the leading edge of the soft plastic flukes, crawfish, swim baits and worms used widely in the field.

### BRIEF DESCRIPTION OF THE DRAWINGS

FIG. 1 shows an isometric view of the invention.

FIG. 2 illustrates a cross-sectional view of the invention

FIG. 3 illustrates an assembly view including the embodiment.

FIG. 4 illustrates a cross-sectional view of the assembly.

### SPECIFICATION

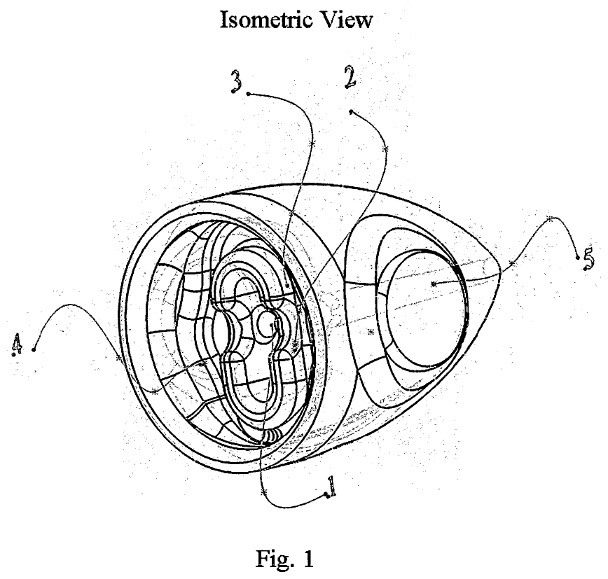

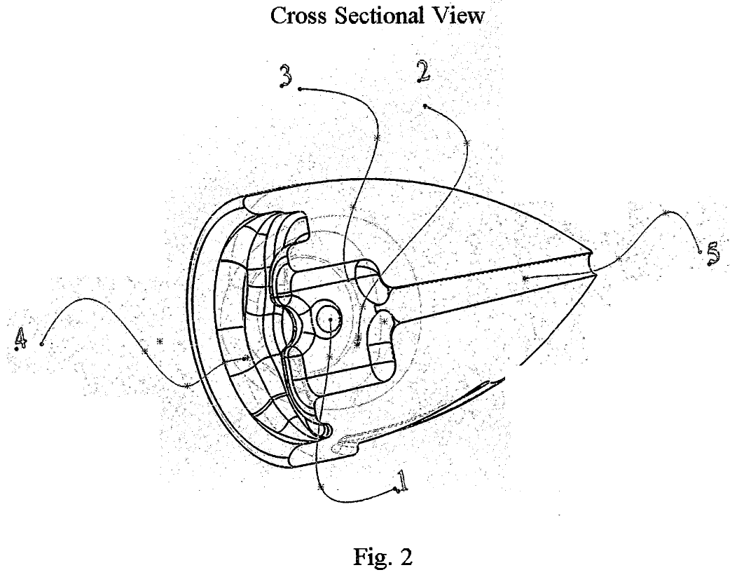

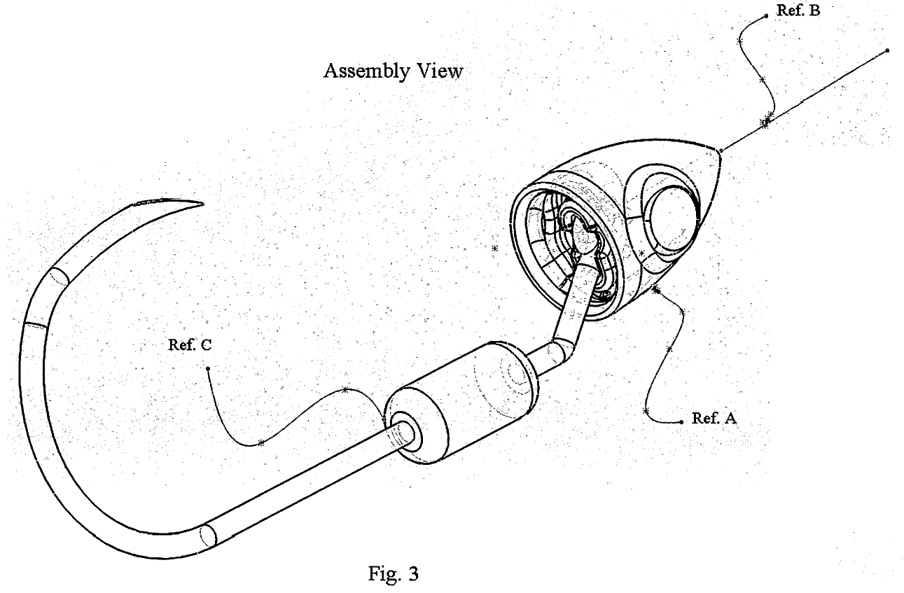

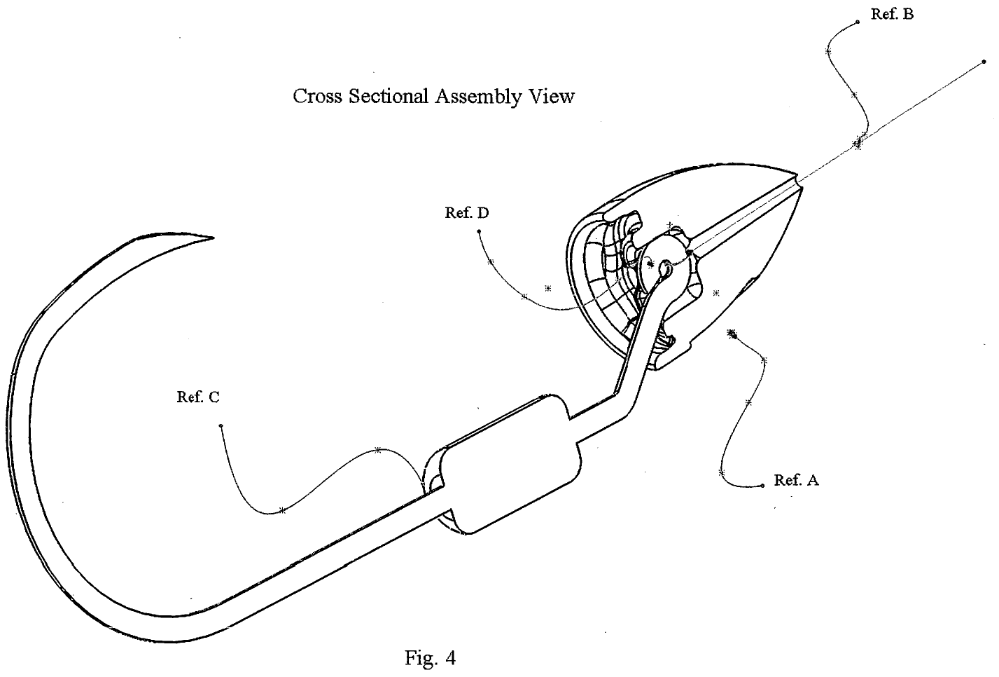

A plastic injection molded, 3D printed or machined embodiment that attaches to a hook eye or shank via one or more locking detent features; FIG. 1.1, FIG. 2.1, FIG. 3 Ref. A and FIG. 4. Ref. A and Ref. D.

Raw Material is a TPE flexible plastic or equivalent to allow snap features to expand and contract over hook features; FIGS. 1,2,3 and 4.

The embodiment contains a recessed pocket to cradle the eye or shank of the hook; FIG. 1.2, FIG. 2.2.

The embodiment contains a recessed pocket to cover the leading edge of a soft plastic bait used widely in the industry, i.e.: flukes, swim baits, crawfish and worms: FIG. 1.4, FIG. 2.4.

The embodiment contains a hole thru the nose or head to thread fishing line thru to tie off on a hook. FIG. 1.5, FIG. 3 Ref.B, FIG. 4 Ref.B.

1. An embodiment that is constructed of flexible plastic material and contains one or more special features that allow for a snap fit onto the eye or shank section of a fishing hook.

2. An embodiment that that contains a pocket to cover the leading edge of a soft plastic artificial bait,

3. An embodiment that contains an internal pocket to capture the knot tied to a fishing hook that allows for vertical swivel movement when snapped on to the eye or shank of a fishing hook.
